(19) United States
(12) Patent Application Publication
(10) Pub. No.: US 2007/0234419 A1
(43) Pub. Date: Oct. 4, 2007

(54) IMAGE FORMING APPARATUS, CONTROL METHOD THEREOF, SYSTEM, PROGRAM, AND STORAGE MEDIUM

(75) Inventor: Hiroki Shouno, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/691,637

(22) Filed: Mar. 27, 2007

(30) Foreign Application Priority Data
Mar. 28, 2006 (JP) 2006-089180
Jan. 31, 2007 (JP) 2007-022238

(51) Int. Cl. G06F 15/16; G06F 17/00; G06F 9/00

(52) U.S. Cl. 726/15

(57) ABSTRACT

An image forming apparatus connectable to a virtual network that requires an authentication process upon connection, includes an input unit configured to input authentication information corresponding to a virtual network of interest as a connection target of the image forming apparatus, wherein the virtual network of interest is part of a plurality of virtual networks, and a request unit configured to send, to an authentication unit, a connection request to the virtual network of interest, including the authentication information, and a communication unit configured to communicate with an external device communicable in the virtual network of interest based on settings complying with a response from the authentication unit.

### BACKGROUND OF THE INVENTION

1. Field of the Invention

The present invention relates to a virtual network and, more particularly, to a VLAN technology.

2. Description of the Related Art

LANs (Local Area Networks) have been developed as the current mainstream of indoor networks along with the popularization of personal computers. In a time sharing system formerly employed, a plurality of terminals connected to one host computer, and processes were executed on the host computer.

Japanese Patent Laid-Open No. 2004-102914 discloses a technique of causing a VLAN (Virtual LAN) to connect printers and personal computers in LANs that transmit a variety of protocols. A VLAN virtually subdivides LANs that are physically arranged in environments.

A printer or MFP (Multi-Functional Peripheral) installed in a place many unspecified persons visit, including a conference room and a space for business talks, often connects to a network environment with public settings that allow access from such unspecified persons due to its application purpose. In many cases, the communication range of a public network environment is fixed and limited from the viewpoint of security. For example, a user may be unable to access another network environment of his/her desire. This system inhibits an arbitrary user from, e.g., connecting an MFP to a server on a specific network to do Send or reference print on the occasion of a conference.

### SUMMARY OF THE INVENTION

The present invention is provided to impart an authentication function to an image forming apparatus such as an MFP or printer, thereby improving the convenience.

An image forming apparatus connectable to a virtual network that requires an authentication process upon connection comprises an input unit configured to input authentication information corresponding to a virtual network of interest as a connection target of the image forming apparatus, wherein the virtual network of interest is part of a plurality of virtual networks, a request unit configured to send, to an authentication unit, a connection request to the virtual network of interest, including the authentication information, and a communication unit configured to communicate with an external device communicable in the virtual network of interest based on settings complying with a response from the authentication unit.

Further features of the present invention will become apparent from the following description of exemplary embodiments with reference to the attached drawings.

### BRIEF DESCRIPTION OF THE DRAWINGS

FIG. 1 is a block diagram showing an example configuration of a system according to the first embodiment of the present invention;

FIG. 2 is a block diagram showing an example hardware configuration of an MFP 101;

FIG. 3 is a block diagram showing an example 4-port VLAN switch 301 and nodes connected to it;

FIG. 4 is a view showing an example arrangement that connects two VLAN switches each of which has four ports of access links connected to a PC or MFP;

FIG. 5 is a view showing an IEEE802.1Q packet structure;

FIG. 6 is a view showing an example arrangement that connects two PCs, a printer, a DHCP server, and an authentication server to a VLAN switch;

FIG. 7 is a view showing an example arrangement of a table that registers passwords and assigned VLANs corresponding to registered user IDs in association with each other;

FIG. 8 is a view showing a display example of a standard authentication VLAN setting window displayed on a panel 206 of the MFP 101;

FIG. 9 is a flowchart showing example processes executed by the MFP 101, authentication VLAN switch 108, and authentication server 107 when the MFP 101 is powered on to log in to an authentication VLAN;

FIG. 10 is a view showing an example arrangement of a table which indicates the relationship between IP addresses and VLANs assigned to nodes connected to the Ethernet®;

FIG. 11 is a view showing an example arrangement of a table that registers passwords, assigned VLANs, and assigned IP addresses corresponding to registered user IDs;

FIG. 12 is a flowchart showing an example process executed by the MFP 101 when it is activated to log in to an authentication VLAN other than a standard VLAN;

FIG. 13 is a view showing a display example of an interrupt login operation window;

FIG. 14 is a flowchart showing an example process executed by the MFP 101 upon login using the window shown in FIG. 15;

FIG. 15 is a view showing a display example of a timer-programmed interrupt login setting window;

FIG. 16 is a block diagram showing an example hardware configuration of the authentication server 107;

FIG. 17 is a flowchart showing a first process example of the MFP 101 that has logged in to the authentication VLAN; and

FIG. 18 is a flowchart showing a second process example of the MFP 101 that has logged in to the authentication VLAN.

### DESCRIPTION OF THE EMBODIMENTS

The preferred embodiments of the present invention will be described below in detail with reference to the accompanying drawings.

### First Exemplary Embodiment

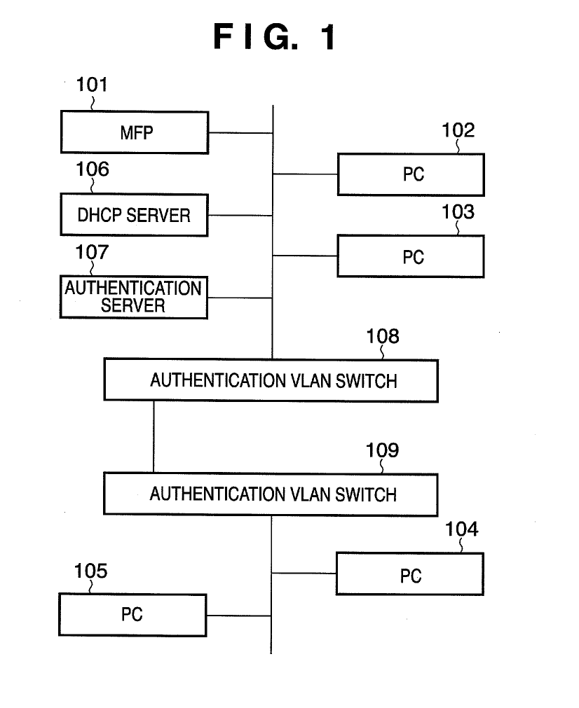

FIG. 1 is a block diagram showing an example configuration of a system according to the first embodiment. The network of this embodiment is Ethernet® with a plurality of nodes connected. The network of this embodiment includes, e.g., a sub-network provided on the first floor, and a sub-network provided on the second floor.

An MFP (Multi-Functional Peripheral) 101 and PCs (Personal Computers) 102 and 103 connect to the sub-network on the first floor. A DHCP server (network setting issue server) 106 and an authentication server 107 functioning as an authentication unit to execute access authentication to an authentication VLAN also connect to the sub-network. These nodes connect to the access link ports of an authentication VLAN switch 108. PCs 104 and 105 connect to ten sub-networks on the second floor. These nodes connect to the access link ports of an authentication VLAN switch 109. The authentication VLAN switches 108 and 109 connect to each other's trunk ports. The operation, arrangement, and role of each node will be described later.

An explanation will be given below by exemplifying an authentication VLAN. However, the present invention is applicable not only to a virtual LAN (authentication VLAN) but also to any other virtual network such as a VPN (Virtual Private Network) that requires a user authentication process for connection. A user's desired virtual network to which a device is connected by the authentication process will be referred to as a virtual network of interest.

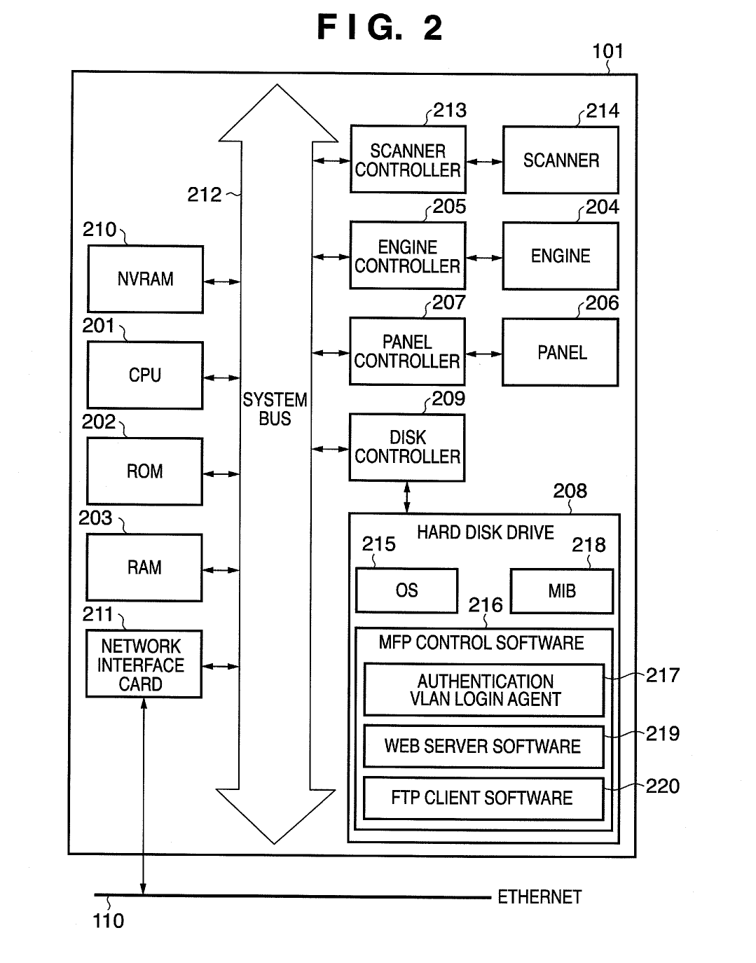

FIG. 2 is a block diagram showing an example hardware configuration of the MFP 101 connectable to a virtual network.

Reference numeral 210 denotes an NVRAM (nonvolatile memory). A CPU 201 controls the overall MFP 101 and executes processes (to be described later) of the MFP 101 by using programs and data stored in a RAM 203 and a ROM 202.

The ROM 202 stores programs and data to make the CPU 201 control the MFP 101. The programs and data are loaded to the RAM 203 as needed under the control of the CPU 201 and processed by the CPU 201.

The RAM 203 has an area to temporarily store data externally received via a network interface card 211, scanner controller 213, and panel controller 207. The RAM 203 also has an area to temporarily store programs and data loaded from a hard disk drive 208 via a disk controller 209. The RAM 203 also has a work area used by the CPU 201 to execute processes by using the various kinds of programs and data. That is, the RAM 203 can provide areas to temporarily store various kinds of information as needed.

The network interface card 211 functions as an interface to connect the MFP 101 to an Ethernet® 110. Via the network interface card 211, the MFP 101 can perform data communication with various devices connected to the Ethernet® 110.

A scanner 214 reads information printed on a print medium such as a paper sheet as an image signal. The scanner controller 213 drives and controls the scanner 214. The scanner controller 213 drives and controls the scanner 214 and outputs the image signal read by it to the RAM 203 or hard disk drive 208 as image data.

A printer engine 204 prints an image or text on a print medium such as a paper sheet based on data received via an engine controller 205. The engine controller 205 drives and controls the printer engine 204.

A panel 206 includes, e.g. a touch panel type liquid crystal display screen so that the operator of the MFP 101 can input various kinds of instructions by pointing the screen with, e.g., a finger. The display screen of the panel 206 can display various kinds of information such as a print setting window and scan setting window. The panel controller 207 drives and controls the panel 206.

The hard disk drive 208 saves an OS (Operating System) 215 as a typical program. The hard disk drive 208 also saves an MIB (Management Information Base) 218 serving as a database of information about peripheral devices. The hard disk drive 208 also saves MFP control software 216 to make the CPU 201 control the overall MFP 101. The hard disk drive 208 also saves an authentication VLAN login agent 217 used to access an authentication VLAN (to be described later). The programs and data are loaded to the RAM 203 as needed under the control of the CPU 201 and processed by the CPU 201.

Web server software (also called a Web server) 219 makes the MFP 101 function as a Web server. An external node that has accessed the Web server via the network can display, on its Web browser, Web pages that are made open to the public by the Web server software. The public Web pages provided by the Web server software 219 include a page that enables network settings and reference to expendables or device information of the MFP 101. The expendables include toners and paper sheets. The device information indicates the product name and the types of optional devices. FTP (File Transfer Protocol) client software 220 transmits a file to an FTP server by using an FTP protocol. The scanner controller 213 transfers data scanned by the scanner 214 to the MFP control software 216. The data that has undergone image processing by the MFP control software is held in the hard disk drive 208. The FTP client software 220 transmits the held data to the FTP server via the network as needed.

The programs and data saved in the hard disk drive 208 are merely examples. The hard disk drive 208 also saves any other programs and data to, e.g., make the CPU 201 execute processes (to be described later) of the MFP 101. Further, a system bus 212 connects the above-described units, as shown in FIG. 2.

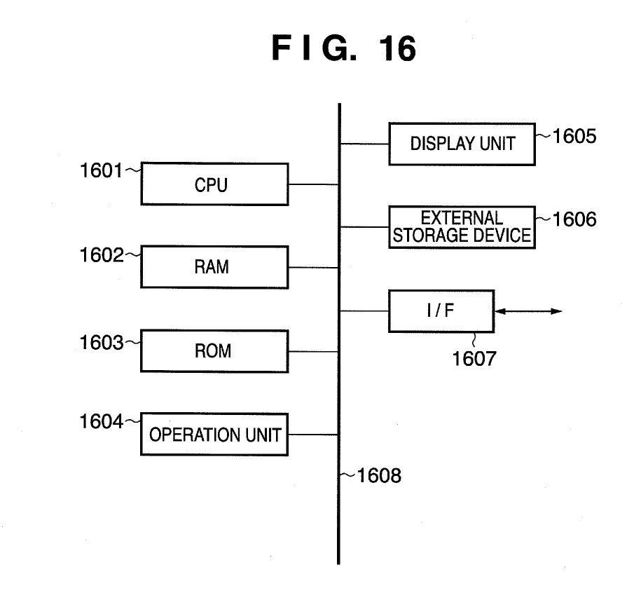

FIG. 16 is a block diagram showing an example hardware configuration of the authentication server 107 functioning as an authentication unit.

A CPU 1601 controls the authentication server 107 and executes processes (to be described later) of the authentication server 107 by using programs and data stored in a RAM 1602 and a ROM 1603.

The RAM 1602 has an area to temporarily store programs and data loaded from an external storage device 1606 or data externally received via an I/F (interface) 1607. The RAM 1602 also has a work area used by the CPU 1601 to execute the various kinds of processes. That is, the RAM 1602 can provide various storage areas as needed. The ROM 1603 stores setting data and boot programs of the authentication server 107.

An operation unit 1604 includes a keyboard and a mouse. The operator of the authentication server 107 can input various kinds of instructions by operating the operation unit 1604. A display unit 1605 includes a CRT or a liquid crystal display screen so that a process result of the CPU 1601 can be displayed as an image or a text.

The external storage device 1606 is a mass storage device represented by a hard disk drive. The external storage device 1606 saves an OS (Operating System), and programs and data to make the CPU 1601 execute the processes (to be described later) of the authentication server 107. The programs and data are loaded to the RAM 1602 as needed under the control of the CPU 1601. The CPU 1601 executes processes using the loaded programs and data, thereby executing the processes (to be described later) of the authentication server 107.

The I/F 1607 connects the authentication server 107 to the Ethernet® 110. The authentication server 107 performs data communication, via the I/F 1607, with various kinds of devices connected to the Ethernet® 110. A bus 1608 connects the above-described units.

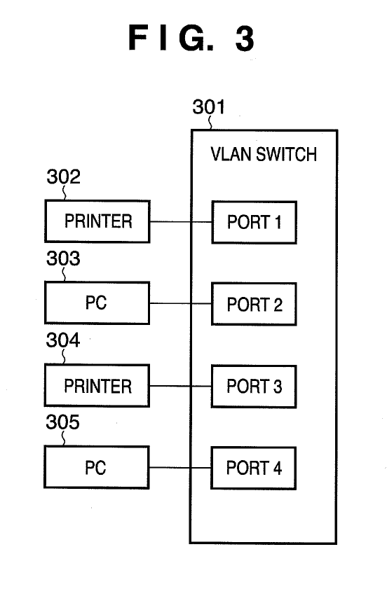

A VLAN communication method, authentication method, and node VLAN assigning method in the authentication VLAN according to this embodiment will be described next. A general VLAN (static VLAN) that requires no authentication will be described first with reference to FIGS. 3 to 5.

An authentication VLAN is based on an extended static VLAN technology. Hence, a method of implementing a static VLAN will be explained first. FIG. 3 is a block diagram showing a 4-port VLAN switch 301 and nodes connected to it. A printer 302 connects to port 1. A PC 303 connects to port 2. A printer 304 connects to port 3. A PC 305 connects to port 4.

The VLAN switch 301 is based on a layer 2 switch. A VLAN function is added to it. The VLAN switch 301 can assign a broadcast domain to each port. Upon receiving a broadcast packet from a port, the switch transfers it only to the same port as the broadcast domain. The assigned broadcast domain corresponds to a VLAN. For example, assume that a VLAN-3a is assigned to ports 1 and 2, and a VLAN-3b is assigned to ports 3 and 4 (“VLAN-3a” and “VLAN-3b” are names to help identifying VLANs).

In this case, a broadcast packet sent from the printer 302 and received by port 1 is transferred only to port 2 of the same VLAN. A broadcast packet sent from the printer 304 and received by port 4 is transferred only to port 3. Packets from ports 1 and 2 are not transferred to ports 3 and 4, and vice versa. The administrator of the LAN can virtually divide it by setting broadcast domains in the layer 2 switch. The administrator can freely set the VLANs assigned to the ports by operating the VLAN switch 301.

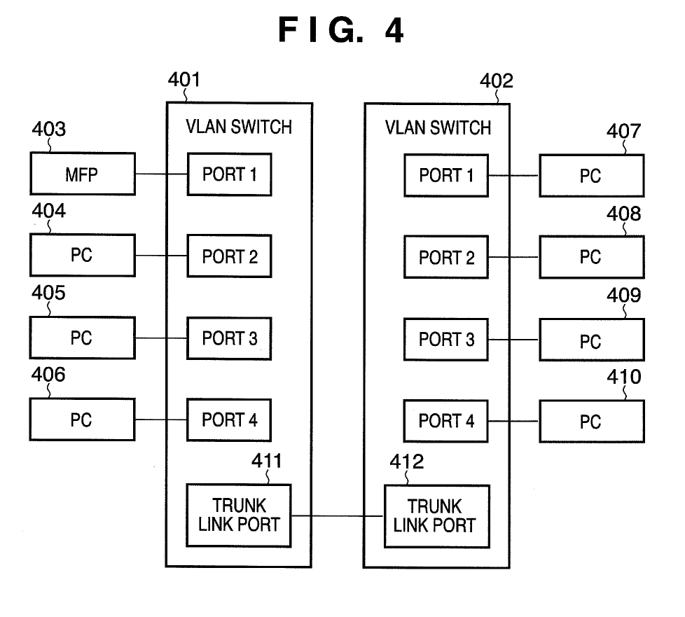

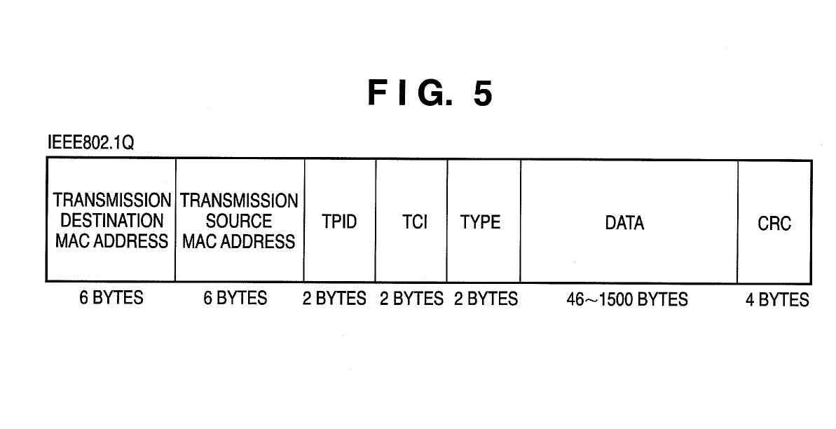

A technique of forming a VLAN by using a plurality of VLAN layer 2 switches will be described next with reference to FIGS. 4 and 5. A technique called “trunk link” is used to make switches share a VLAN environment. In this embodiment, a VLAN between switches is formed by the trunk link. A trunk link is a port capable of transferring traffic between a plurality of VLANs. A packet that flows between layer 2 switches by using this port has information added to identify the VLAN having control over the packet.

A transmitting-side layer 2 switch adds VLAN identification information to a packet and transmits it. A layer 2 switch that has received the packet can identify its transfer destination port by referring to the VLAN identification information. VLAN identification information has a standard called IEEE802.1Q and a standard unique to a vender. This embodiment employs communication using IEEE802.1Q. IEEE802.1Q is a protocol to add identification information to identify a VLAN on a trunk link. The IEEE802.1Q packet structure is like an extension of an Ethernet® frame. FIG. 5 shows the IEEE802.1Q packet structure.

In IEEE802.1Q, VLAN identification information is inserted between the transmission source MAC address and type of the frame. The inserted information contains a 2-byte TPID and a 2-byte TCI, i.e., a total of four bytes. The frame CRC calculation method is different from that of Ethernet® because of insertion of the four bytes. To transfer an Ethernet® frame received by an access link port to the trunk link, a VLAN layer 2 switch inserts these pieces of information and then transfers the frame. An IEEE802.1Q frame input from the trunk link is transferred to an access link port of a corresponding VLAN after removing the pieces of information.

FIG. 4 is a view showing an arrangement that connects two VLAN switches each of which has four ports of access links connected to a PC or MFP. As shown in FIG. 4, a VLAN switch 401 has four ports of access links. An MFP 403 connects to port 1. A PC 404 connects to port 2. A PC 405 connects to port 3. A PC 406 connects to port 4. In addition, a VLAN switch 402 has four ports of access links. A PC 407 connects to port 1. A PC 408 connects to port 2. A PC 409 connects to port 3. A PC 410 connects to port 4. The VLAN switch 401 has a trunk link port 411. The VLAN switch 402 has a trunk link port 412. The trunk link ports 411 and 412 are connected via an Ethernet® cable.

A VLAN-4a is assigned to ports 1 and 2 of the VLAN switch 401. A VLAN-4b is assigned to ports 3 and 4 of the VLAN switch 401. The VLAN-4a is assigned to ports 1 and 2 of the VLAN switch 402. The VLAN-4b is assigned to ports 3 and 4 of the VLAN switch 402 (“VLAN-4a” and “VLAN-4b” are names to help identifying VLANs). In this case, a broadcast packet sent from the MFP 403 and received by port 1 of the VLAN switch 401 is transferred to port 2 of the same VLAN by the VLAN switch 401. The broadcast packet is never transferred to port 3 or 4 of the VLAN switch 401 of different VLAN.

Simultaneously, the VLAN switch 401 transfers the broadcast packet received by port 1 to the trunk link port 411. At this time, the VLAN switch 401 changes the Ethernet® frame to an IEEE802.1Q frame. The VLAN switch 401 inserts TPID information (0x8100) and a TCI containing 12-bit VLAN identification information into the Ethernet® frame, recalculates the CRC, and sends the IEEE802.1Q frame from the trunk link port 411. The trunk link port 412 of the VLAN switch 402 receives the IEEE802.1Q frame sent from the VLAN switch 401.

The VLAN switch 402 removes the TPID information and TCI information from the IEEE802.1Q frame, recalculates the CRC to form an Ethernet® frame, and transfers it to an access link port. The transfer destination port is a port under the VLAN-4a, i.e., port 1 or 2. The VLAN switch 402 determines the transfer destination access link port by referring to the TCI information of the received IEEE802.1Q frame. An Ethernet® frame sent from a given node is never transferred to an access link port with a different VLAN registered.

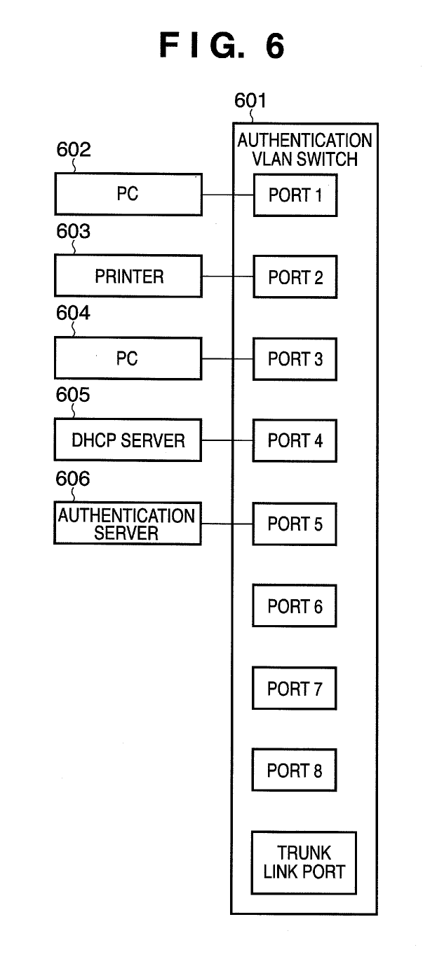

An example access request operation to an authentication VLAN and a VLAN deciding operation of this embodiment will be described next with reference to FIG. 6. FIG. 6 is a view showing an arrangement that connects two PCs, a printer, a DHCP server, and an authentication server to a VLAN switch.

As shown in FIG. 6, an authentication VLAN switch 601 has eight ports of access link ports. A PC 602 connects to port 1. A printer 603 connects to port 2. A PC 604 connects to port 3. A DHCP server 605 which distributes network configuration information such as an IP address by a DHCP protocol connects to port 4. An authentication server 606 connects to port 5.

The authentication VLAN switch 601 has three VLANs, i.e., VLAN-6a, VLAN-6b, and default VLAN. The printer 603 belongs to the VLAN-6a. The PC 604 currently belongs to the VLAN-6b. The DHCP server 605 and authentication server 606 belong to the default VLAN. Unauthenticated nodes belong to the default VLAN. The nodes belonging to the default VLAN can communicate with the DHCP server 605 and authentication server 606 but are isolated from all authenticated nodes.

The authentication VLAN switch 601 assigns an unauthenticated node after power-on to the VLAN. There is no routing between the VLAN-6a and VLAN-6b. Assume that the PC 602 will participate in the authentication VLAN.

The PC 602 is powered on and loads the operating system stored in its HDD (Hard Disk Drive). The operating system determines network configurations such as an IP address and subnet mask of the PC 602 during activation. DHCP is used here. The PC 602 sends a DHCP request and receives network information from the DHCP server 605. When the operating system is activated, a VLAN authentication agent is activated on it. This software prompts the operator to do user authentication to authenticate the user who uses the PC 602.

The operator of the PC 602 inputs his/her registered user ID and password to the registered user ID and password input fields displayed in the window of the VLAN authentication agent. Upon receiving the user's registered user ID and password, the VLAN authentication agent issues an authentication request to the authentication server 606. The IP address of the authentication server 606 is known in advance.

In this embodiment, the authentication server and protocol employ RADIUS (Remote Authentication Dial-In User Service). The RADIUS was developed for the purpose of user authentication of a remote access server. Nowadays, this protocol is often used for authentication in a LAN and even in a VLAN having an authentication function. A RADIUS packet structure is roughly divided into an identification code part and an attribute pair part. It also contains other pieces of information, and a description thereof will be omitted here. The identification code part contains an operation type, including operation request, access permission, and access rejection. The attribute pair part is an area to describe various kinds of attributes defined by the RADIUS protocol and their values. The attribute is information required by an authentication server or authentication client. The attribute value is defined by the type. For example, a user name used in an access request is defined as User-Name (1). A password is defined as User-Password (2).

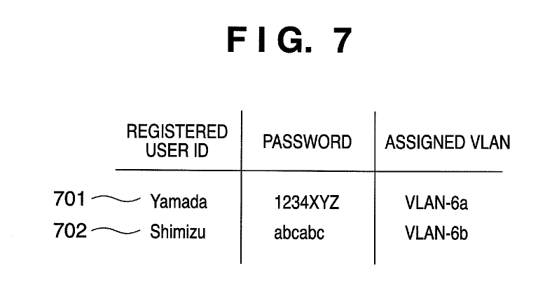

The PC 602 sends a RADIUS authentication request to the authentication server 606. The authentication VLAN switch 601 receives the sent packet by port 1 of access link. The authentication VLAN switch 601 transfers the packet to a port connected to the authentication server 606. The authentication server 606 receives the packet. Since the transmission destination port of the received packet is a RADIUS authentication port, the socket program module running on the authentication server 606 transfers the UDP packet data to the RADIUS execution module in the authentication server 606. The RADIUS execution module in the authentication server 606 will be referred to as a RADIUS module hereinafter. The RADIUS module refers to the identification code of the received data and determines that the value indicates an authentication request. The RADIUS module refers to the user name and password included in the attribute pair part and determines whether they match the authentication table managed by the module. If the user name of the operator of the PC 602 has been registered in the authentication table of the RADIUS module, and a corresponding password also has the same value as the password input by the operator, the RADIUS module determines that authentication proves successful and replies with an access permission. The authentication table of the RADIUS module has, e.g., an arrangement shown in FIG. 7.

FIG. 7 is a view showing an arrangement example of a table that registers passwords and assigned VLANs corresponding to registered user IDs in association with each other. These pieces of information are saved in the external storage device 1606 of the authentication server 606 as data. In fact, password information is encrypted. A row 701 registers a password and assigned VLAN corresponding to a user name “Yamada.” The password is “1234XYZ,” and the assigned VLAN is “VLAN-6a.” A row 702 registers a password and assigned VLAN corresponding to a user name “Shimizu.” The password is “abcabc,” and the assigned VLAN is “VLAN-6b.”

The RADIUS module refers to the User-Name (1) attribute and User-Password (2) of the received RADIUS packet and compares them with the table. If the user name exists in the table, and the password is correct, authentication is successful. If the user name is not present, or the passwords do not match, it is determined that authentication has failed. The RADIUS module returns the authentication result. If authentication has failed, the RADIUS module returns an Access-Reject code. If authentication has succeeded, the RADIUS module returns an Access-Accept code. In returning the Access-Accept code, the RADIUS module adds VLAN information of the operator of the PC 602 to the reply packet. For example, when the operator of the PC 602 is “Yamada,” “VLAN-6a” is returned. When the operator of the PC 602 is “Shimizu,” “VLAN-6b” is returned.

The RADIUS module discriminates the VLAN to which the operator belongs by referring to the authentication table and adds information. The information is added to the attribute pair part and has an attribute value “26” (Vender-Specific). The RADIUS module adds, as the attribute value, an identifier indicating the assigned VLAN corresponding to the registered user ID of the operator and sends the packet to the PC 602. The sent packet is received by port 5 of the authentication VLAN switch 601.

The authentication VLAN switch 601 refers to the destination MAC address. Since it is the address of the PC 602, the packet is transferred to port 1 connected to the PC 602. At this time, the authentication VLAN switch 601 determines that authentication of the PC 602 has succeeded and discriminates the VLAN of the PC 602 by referring to the identification code part and attribute pair part of the packet. For example, when the operator of the PC 602 is “Yamada,” the authentication VLAN switch 601 determines that the VLAN corresponding to the PC 602 is the VLAN-6a. Then, the authentication VLAN switch 601 operates the port connected to the PC 602 as the VLAN-6a. With this process, the PC 602 belongs to the VLAN-6a and can communicate with the printer 603. The arrangement and operation of a general authentication VLAN have been described above. This is an example of the means for forming an authentication VLAN. Another means for, e.g., forming an authentication VLAN based on the IEEE802.1x standard is also available.

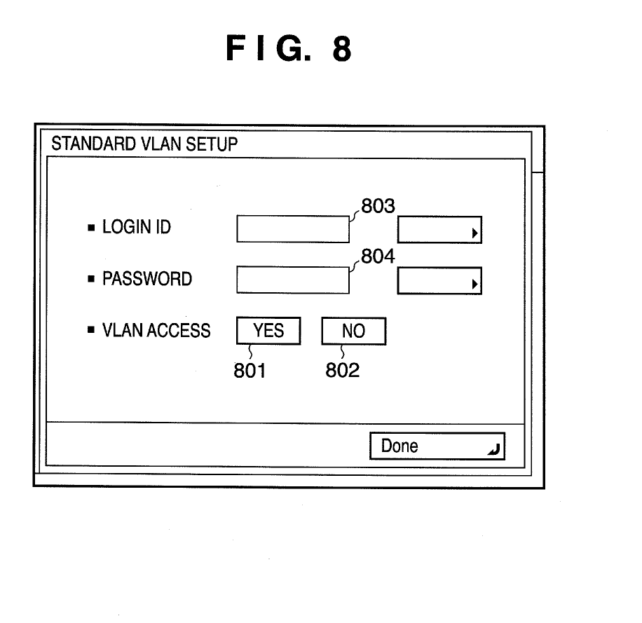

This embodiment and the second embodiment to be described later are based on the above-described arrangement and communication operation of the authentication VLAN. Based on those, the operation of the MFP 101 of this embodiment will be described. FIG. 8 is a view showing a display example of a standard authentication VLAN setting window displayed on the panel 206 of the MFP 101.

The MFP 101 provides a UI (User Interface) capable of various settings of it to the administrator or user of the MFP 101. The administrator or user of the MFP 101 can input setting information to various setting items displayed on the panel 206 so that the MFP 101 can perform an operation (setting process) adapted to the environment.

Examples of the setting items are the network information, print quality information, nickname, and time information of the MFP 101. The administrator of the MFP 101 sets its IP address by acquisition through DHCP and makes the MFP 101 adapted to the environment shown in FIG. 1. He/she also executes default VLAN settings of the MFP 101 by using the same window as in FIG. 8. A description will be given below by using notations of the default VLAN. The default VLAN only needs to be able to provide a network environment that allows the image forming apparatus to access the authentication server 107. Hence, the settings are applicable to both the default VLAN and the authentication VLAN.

The standard authentication VLAN is an authentication VLAN to which the MFP 101 in the normal state logs in. To the contrary, the default VLAN communicates with the authentication server 107 to set the network environment of the standard authentication VLAN. When the default VLAN is formed from the authentication VLAN, the standard authentication VLAN and the default authentication VLAN may have the same settings. The standard authentication VLAN settings of the MFP 101 include three items shown in FIG. 8.

Button images 801 and 802 set whether the MFP 101 should access the authentication VLAN. If no authentication VLAN is installed in the installation environment of the MFP 101, the user designates the “NO” button image 802 to invalidate the authentication VLAN function of the MFP 101. When the user designates the “YES” button image 801, the MFP 101 should issue an access request to the authentication VLAN. The following description will be done assuming that the “YES” button image 801 is designated.

The user inputs a login ID (registered user ID) to a field 803. In issuing an authentication VLAN access request to the authentication server 107 (to be described later), the login ID is included in the request and sent to the authentication server 107.

In issuing an authentication VLAN access request to the authentication server 107 (to be described later), a password 804 is included in the request and sent to the authentication server 107. As described above, the authentication server 107 decides the possibility of authentication by checking whether the received set of the login ID and password is registered in it. Hence, the user must input a login ID and a password which are issued in advance as a set to the fields 803 and 804.

The ROM 202 or hard disk drive 208 saves the programs and data related to various display windows including the window shown in FIG. 8. When saved data is loaded to the RAM 203, and the CPU 201 executes a process by using the data, the panel 206 of the MFP 101 displays a corresponding window. The user can input various settings by using this window.

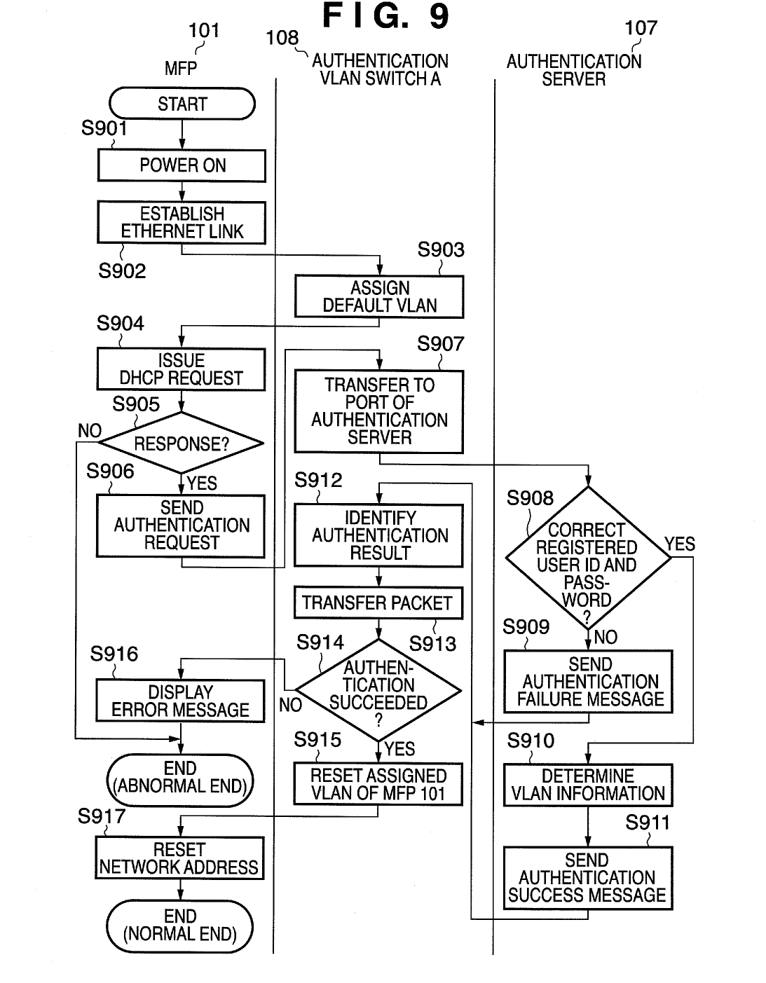

Exemplary processes executed by the MFP 101, authentication VLAN switch 108, and authentication server 107 when the MFP 101 is powered on to log in to the standard authentication VLAN will be described next with reference to FIG. 9 that shows the flowchart of the processes. The programs and data to cause each device to execute its process are saved in the memory of the device. The CPU of each device executes the process by using the programs and data saved in the memory of the device so that the device executes the process corresponding to the flowchart in FIG. 9. The CPU can be substituted with an equivalent processor.

In, e.g., the MFP 101, the programs and data to cause the CPU 201 to execute the process parts (S901, S902, S904 to S906, S916, and S917) of the MFP 101 are saved in the hard disk drive 208. The programs and data are loaded to the RAM 203 as needed under the control of the CPU 201. The CPU 201 executes the process by using them so that the MFP 101 executes the processes in steps S901, S902, S904 to S906, S916, and S917.

In the authentication server 107, the programs and data to cause the CPU 1601 to execute the process parts (S908 to S911) of the authentication server 107 are saved in the external storage device 1606. The programs and data are loaded to the RAM 1602 as needed under the control of the CPU 1601. The CPU 1601 executes the process by using them so that the authentication server 107 executes the processes in steps S908 to S911.

Now referring to FIG. 9, when the MFP 101 is powered on in step S901, the CPU 201 activates the units of the MFP 101 by using various kinds of programs and data stored in the ROM 202 and loads necessary software programs and data to the RAM 203.

In step S902, the CPU 201 executes a process to establish an Ethernet® link. More specifically, the CPU 201 establishes a link to the Ethernet® 110 by controlling the network interface card 211. When the link is established, the authentication VLAN switch 108 switches the VLAN of the port connected to the MFP 101 to the default VLAN in step S903. With this process, the MFP 101 has only the node assigned to the default VLAN as the broadcast domain.

To issue a connection request to a predetermined network environment upon activation and execute communication with the authentication server 107 in this network environment, the process in this step can be modified as needed.

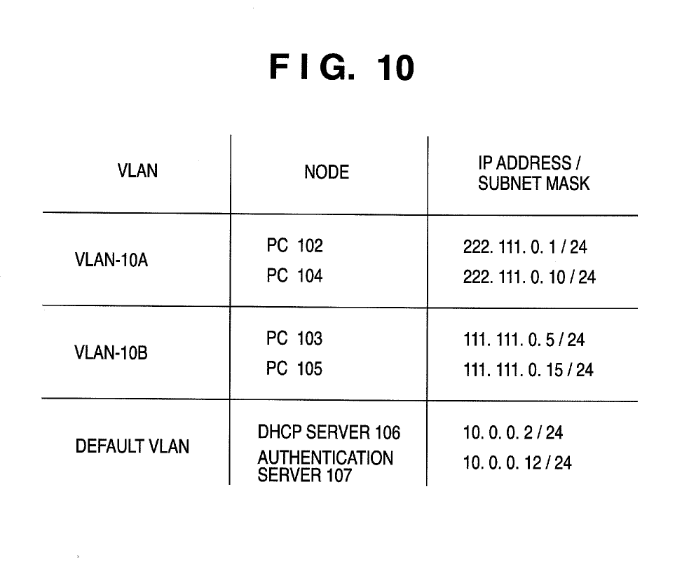

The assigned VLAN and IP address of the node connected to the Ethernet® 110 will be described here with reference to FIG. 10.

In this embodiment, the Ethernet® 110 has three kinds of VLANs which are implemented by the authentication VLAN switches 108 and 109.

As shown in FIG. 10, the PCs 102 and 104 belong to a VLAN-10A. The IP address and subnet mask of the PC 102 are 222.111.0.1/24. The IP address and subnet mask of the PC 104 are 222.111.0.10/24. The PCs 103 and 105 connect to a VLAN-10B. The IP address and subnet mask of the PC 103 are 111.111.0.5/24. The IP address and subnet mask of the PC 105 are 111.111.0.15/24. The default VLAN is basically a temporary VLAN assigned to a node before authentication. The DHCP server 106 to receive supply of an IP address for an operation in the default VLAN and the authentication server 107 to execute authentication belong to the default VLAN. The IP address and subnet mask of the DHCP server 106 are 10.0.0.2/24. The IP address and subnet mask of the authentication server 107 are 10.0.0.12/24.

As described above, the three kinds of VLANs are partitioned by the OSI second layer formed by the authentication VLAN switches 108 and 109. Their IPs also belong to different networks. In the default VLAN assignment process in step S903, the MFP 101 is not notified of assignment itself. However, the MFP 101 determines that the Ethernet® is usable when link to the Ethernet® 110 is allowed.

Referring back to FIG. 9, in step S904, the MFP 101 issues a DHCP request to the DHCP server 106 and acquires the IP information of the MFP 101. The MFP 101 sends a DHCP packet. At this time, the operation code of the DHCP protocol is BOOTREQUEST (1). The MFP 101 sends the DHCP request packet to the broadcast address. The authentication VLAN switch 108 receives the DHCP packet. Since the transmission destination MAC address is the broadcast address, the authentication VLAN switch 108 transfers the packet to the broadcast domain of the VLAN to which the MFP 101 belongs. The DHCP server 106 connects to the broadcast domain of the default VLAN as the VLAN of the MFP 101. For this reason, the DHCP server 106 receives the DHCP request sent from the MFP 101 and returns, to the MFP 101, a reply packet containing network information corresponding to the settings in the DHCP server 106. This reply is performed when neither communication error nor unauthorized process of the DHCP server is present.

The assigned IP address is an address included in the network of the default VLAN. If the MFP 101 cannot receive the reply packet due to some failure or abnormal process, the MFP 101 cannot acquire the IP address and execute IP communication with another node. Hence, the process cannot continue any more. For example, if the MFP 101 does not detect reception of the reply packet for a predetermined time or more, the process is ended (abnormal end) after step S905.

If the MFP 101 detects reception of the reply packet, the process advances from step S905 to step S906. The MFP 101 issues a standard authentication VLAN access request to the authentication server 107. The CPU 201 executes the authentication VLAN login agent 217 loaded from the hard disk drive 208 to the RAM 203 under its control, and the process of issuing an authentication request to the authentication server 107 is executed. The authentication request contains various kinds of information including the registered user ID and password of the standard authentication VLAN which are set by the administrator or user of the MFP 101 using the GUI shown in FIG. 8.

The administrator sets the IP address of the authentication server 107 in advance. The MFP 101 holds the address value as an object of the MIB 218. As the type and protocol of the authentication server 107, RADIUS is employed, as described above.

A RADIUS packet structure is roughly divided into an identification code part and an attribute pair part. It also contains other pieces of information, and a description thereof will be omitted here. The identification code part contains an operation type, including operation request, access permission, and access rejection. The attribute pair part is an area to describe various kinds of attributes defined by the RADIUS protocol and their values. The attribute is information required by an authentication server or authentication client. The attribute value is defined by the type. For example, a user name used in an access request is defined as User-Name (1). A password is defined as User-Password (2).

The MFP 101 sends a RADIUS authentication request (packet) to the authentication server 107. The authentication VLAN switch 108 receives the sent authentication request by the access link port connected to the MFP 101. Hence, in step S907, the authentication VLAN switch 108 transfers the packet to the port connected to the authentication server 107.

In step S908, the authentication server 107 acquires (receives) the packet in the RAM 1602 via the I/F 1607. Since the transmission destination port of the received packet is a RADIUS authentication port, the socket program module running on the authentication server 107 transfers the UDP packet data to the RADIUS module in the authentication server 107. The RADIUS module refers to the identification code of the received data and determines that the value indicates an authentication request.

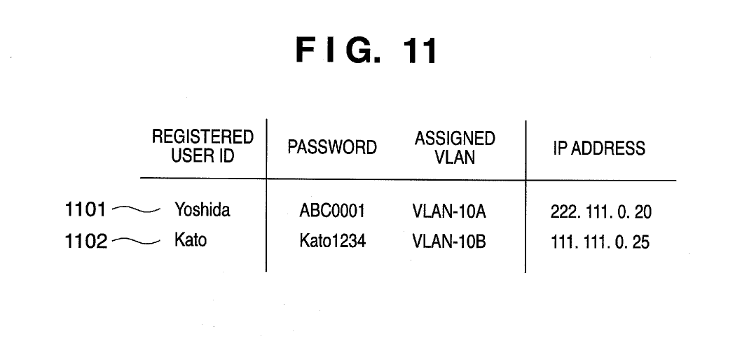

The RADIUS module refers to the user name and password included in the attribute pair part and determines whether they match the authentication table loaded from the external storage device 1606 to the RAM 1602. If the user name of the operator of the MFP 101 has been registered in the authentication table of the RADIUS module, and a corresponding password also has the same value as the password input by the operator, the RADIUS module determines that authentication proves successful and replies with an access permission. The authentication table of the RADIUS module has, e.g., an arrangement shown in FIG. 11.

FIG. 11 is a view showing an arrangement example of a table that registers passwords, assigned VLANs, and assigned IP addresses corresponding to registered user IDs. These pieces of information are saved in the external storage device 1606 of the authentication server 107 as data. In fact, password information is encrypted. A row 1101 registers a password, assigned VLAN, and assigned IP address corresponding to a registered user ID “Yoshida.” Referring to FIG. 11, the password corresponding to the registered user ID “Yoshida” is “ABC0001,” the assigned VLAN is “VLAN-10A,” and the assigned IP address is “222.111.0.20.”

A row 1102 registers a password, assigned VLAN, and assigned IP address corresponding to a registered user ID “Kato.” Referring to FIG. 11, the password corresponding to the registered user ID “Kato” is “Katol234,” the assigned VLAN is “VLAN-10B,” and the assigned IP address is “111.111.0.25.”

The RADIUS module refers to the User-Name (1) attribute and User-Password (2) of the received RADIUS packet and compares them with the authentication table. If the set of the registered user ID and password acquired from the received RADIUS packet has been registered in the authentication table, authentication proves successful. If the set of the registered user ID and password acquired from the received RADIUS packet has not been registered in the authentication table, it is determined that authentication has failed. The process advances from step S908 to step S909. The RADIUS module returns an authentication failure message (Access-Reject code).

If authentication has succeeded, the process advances from step S908 to step S910. The RADIUS module discriminates the VLAN to which the operator of the MFP 101 belongs by referring to the authentication table of the RADIUS module. In step S911, the RADIUS module adds the information of the VLAN to which the operator of the MFP 101 belongs to the reply packet and sends it together with an authentication success message (Access-Accept code).

For example, when the operator of the MFP 101 is “Yoshida,” “VLAN-10A” is returned as an identifier indicating the VLAN, and “222.111.0.20” is returned as a corresponding IP address. When the operator of the MFP 101 is “Kato,” “VLAN-10B” is returned as an identifier indicating the VLAN, and “111.111.0.25” is returned as a corresponding IP address.

The RADIUS module discriminates the VLAN to which the operator belongs by referring to the authentication table and adds information. The information is added to the attribute pair part and has an attribute value “26” (Vender-Specific). The RADIUS module adds, as the attribute value (VLAN information), an identifier indicating the VLAN corresponding to the registered user ID of the operator and a corresponding IP address and sends the packet to the MFP 101.

The sent packet is received by an access link port of the authentication VLAN switch 108, which connects to the authentication server 107. In step S912, the authentication VLAN switch 108 determines that the MFP 101 has succeeded authentication of the authentication VLAN access request and identifies the VLAN assigned to the MFP 101.

For example, when the operator of the MFP 101 is “Yoshida,” the authentication VLAN switch 108 determines that the VLAN corresponding to the MFP 101 is the VLAN-10A. In step S913, the authentication VLAN switch 108 refers to the destination MAC address. Since the destination MAC address is the address of the MFP 101, the authentication VLAN switch 108 transfers the packet to the access link port connected to the MFP 101. Then, if the authentication has succeeded, the process advances from step S914 to step S915 to make the authentication VLAN switch 108 operate the access link port connected to the MFP 101 as the VLAN-10A. With this process, the MFP 101 belongs to the VLAN-10A and can communicate with a node belonging to the VLAN-10A. The MFP 101 receives the reply from the authentication VLAN switch 108 and executes a predetermined process.

If the reply from the authentication VLAN switch 108 is information indicating the failure of authentication, the process advances to step S916. The authentication VLAN login agent 217 interprets the information and transmits the result to the MFP control software 216. To do this, a general method of transmitting data between software modules is employed, although a description of a detailed transmission method will be omitted here. For example, interprocess communication or inner function invocation is used.

Upon receiving the notification representing the failure of authentication, the MFP control software 216 displays, on the panel 206, an error message to notify the user that login to the standard authentication VLAN has failed so the MFP 101 cannot perform network communication.

On the other hand, if the reply packet received by the MFP 101 indicates the success of authentication, the process advances to step S917 after the process in step S915. The authentication VLAN login agent 217 transmits the IP address information included in the received packet to the MFP control software 216. The MFP control software 216 sends a predetermined instruction to the OS 215 to change the IP address of the MFP 101 to the IP address received from the authentication server 107. When the IP address of the MFP 101 changes to the IP address received from the authentication server 107, IP communication can be performed in the VLAN of the MFP 101. The standard authentication VLAN login process upon activating the MFP 101 is thus completed.

Packet transmission in the Ethernet® when the MFP 101 has logged in to the authentication VLAN by using the registered user ID “Yoshida” will be described next. An IP packet sent from the MFP 101 as the broadcast packet is received by an access link port of the authentication VLAN switch 108, which connects to the MFP 101. The authentication VLAN switch 108 transfers the packet to an access link port that is set to the same VLAN as the access link port connected to the MFP 101. The VLAN assigned to the MFP 101 is the VLAN-10A, and the same VLAN is assigned to the PC 102, as is apparent from the correspondence table in FIG. 10. The authentication VLAN switch 108 transfers the packet to the access link port connected to the PC 102. The PC 103, DHCP server 106, and authentication server 107 belong to different VLANs so the authentication VLAN switch 108 does not transfer the packet to them.

Simultaneously, the authentication VLAN switch 108 transfers the packet from the trunk link port of its own to the authentication VLAN switch 109. The authentication VLAN switch 108 transfers the packet containing VLAN information complying with the IEEE802.1Q standard to the authentication VLAN switch 109. First, the authentication VLAN switch 108 changes the Ethernet® frame to an IEEE802.1Q frame. The authentication VLAN switch 108 inserts a TCI containing TPID information (0x8100) and 12-bit VLAN identification information into the Ethernet® frame, recalculates the CRC, and sends the IEEE802.1Q frame from the trunk link port.

The trunk link port of the authentication VLAN switch 109 receives the IEEE802.1Q frame sent from the authentication VLAN switch 108. The authentication VLAN switch 109 removes the TPID information and TCI information from the IEEE802.1Q frame, recalculates the CRC, and transfers the Ethernet® frame to the trunk link port. The transfer destination port is a port under the VLAN-10A, i.e., the port connected to the PC 104. The authentication VLAN switch 109 determines the transfer destination access link port by referring to the TCI information of the received IEEE802.1Q frame. In this way, the IP packet sent from the MFP 101 is transferred only to nodes belonging to the same VLAN.

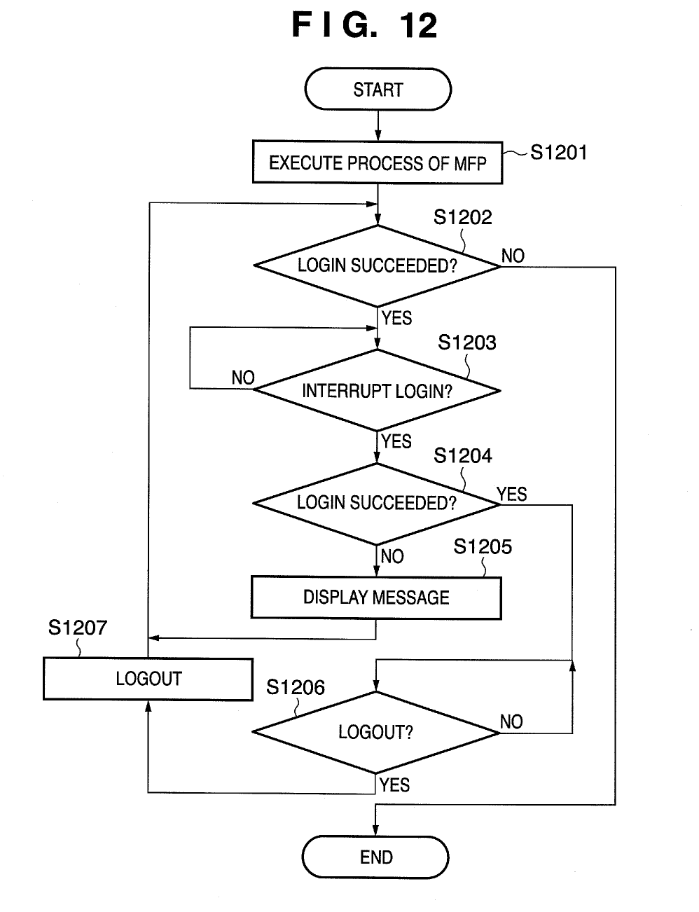

A process executed by the MFP 101 when it is activated to log in to an authentication VLAN other than the standard VLAN will be described next with reference to the flowchart in FIG. 12. The standard VLAN indicates the communication range assigned by the process up to step S917 in the flowchart of FIG. 9. The standard VLAN is a simple expression of the standard authentication VLAN, i.e., indicates the standard authentication VLAN.

In step S1201, the process of the MFP 101 is executed in accordance with the procedure shown in the flowchart of FIG. 9. In step S1202, it is checked in accordance with the procedure shown in the flowchart of FIG. 9 whether login to the authentication VLAN has succeeded. If login to the authentication VLAN based on the standard VLAN account has failed, the MFP 101 cannot execute IP communication. Hence, the process cannot continue any more. The process finishes here. That is, the process is ended after step S1202.

If login to the authentication VLAN based on the standard VLAN account has succeeded, the process advances from step S1202 to step S1203. The MFP 101 executes an interrupt login waiting loop process. The interrupt login is a function of causing the MFP 101 to temporarily log in to a VLAN other than the VLAN set by the standard VLAN.

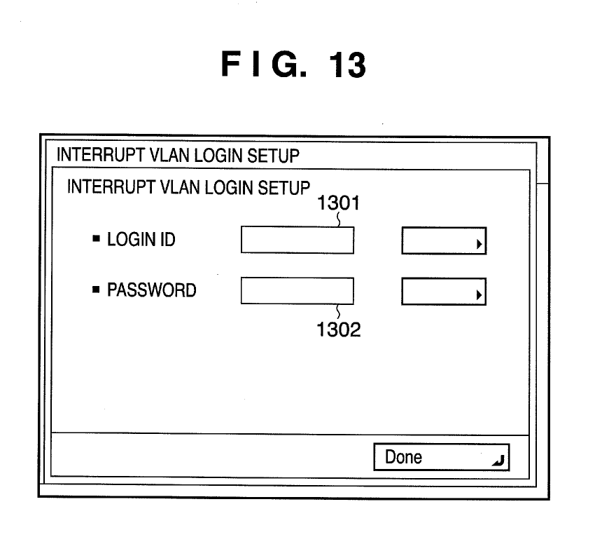

The operator of the MFP 101 inputs an instruction to invoke an interrupt login operation window by operating the UI displayed on the panel 206. Upon receiving this instruction, the MFP 101 displays a window shown in FIG. 13 on the display screen of the panel 206. FIG. 13 is a view showing a display example of the interrupt login operation window.

As shown in FIG. 13, the operation window has a field 1301 to input a registered user ID (login ID), and a field 1302 to input a password. The values input to the fields 1301 and 1302 are associated with the registered user ID and password of the authentication VLAN, about which the user inquires of the RADIUS server. If an interrupt login is input, the process advances from step S1203 to step S1204. The MFP 101 issues an authentication VLAN login request to the authentication server 107 by using the registered user ID and password input in the window shown in FIG. 13. Issue of the authentication VLAN login request and the authentication process by the authentication server 107 and authentication VLAN switch 108 are the same as the process in steps S906 to S917, and a description thereof will be omitted.

The MFP 101 receives information indicating whether the authentication has succeeded. If authentication has failed, the process advances from step S1204 to step S1205. The authentication VLAN login agent 217 displays, on the panel 206, a message indicating the failure of login to the authentication VLAN via the MFP control software 216. To log in to the standard VLAN again, the process returns to step S1202. With this process, the MFP 101 logs in to the preset standard VLAN in case of the failure of interrupt login.

If authentication has succeeded, the process advances from step S1204 to step S1206. The MFP 101 operates as a node on the VLAN set by the interrupt login. In this state, the user can operate the MFP 101 as a node on the VLAN designated by the interrupt login and therefore access, e.g., a destination different from the standard VLAN. When use of the MFP 101 on the VLAN designated by the interrupt login is ended, the user gives the instruction for logout in accordance with an instruction of the UI displayed on the panel 206. When the MFP 101 detects the logout instruction, the process advances from step S1206 to step S1207 to execute the logout process. The process returns to step S1202 to send a standard VLAN access request again. That is, when the interrupt login is ended, the MFP 101 automatically logs in to the standard VLAN.

As described above, according to this embodiment, the image forming apparatus can access the authentication VLAN by using arbitrary authentication information desired by the user of the image forming apparatus. The image forming apparatus can access an authentication VLAN as the access target in the normal state and also another authentication VLAN. For this reason, even the user of an image forming apparatus that is connected to the authentication VLAN for general users can access a specific authentication VLAN. When the access finishes, the image forming apparatus can connect to the authentication VLAN for general users again.

The arrangement and operation method of the display window used in the above-described embodiment and information (registered user ID and password in this embodiment) used for authentication can be modified as needed. The network setting information (VLAN identifier and IP address in this embodiment) can be modified as needed. The essence of the above-described embodiment is applicable even to such various kinds of modifications.

According to the embodiment, for example, an arbitrary user can do Send or reference print in a server on a specific authentication VLAN network by using an MFP (image forming apparatus) on the occasion of, e.g., a conference. Even when a user causes a notebook PC to participate in a user-matter authentication VLAN in, e.g., a conference room, an image forming apparatus can participate in the user-matter authentication VLAN and easily print.

### Second Exemplary Embodiment

In this embodiment, a timer-programmed interrupt login will be described. The second embodiment is based on the first embodiment, and only a difference from the first embodiment will be described below.

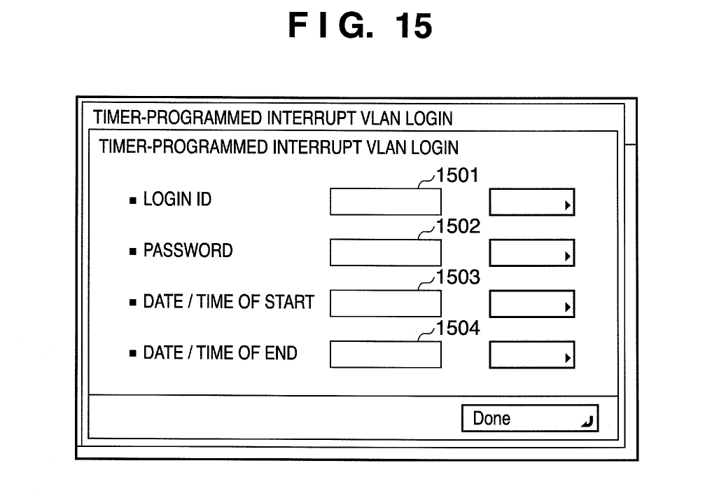

FIG. 15 is a view showing a display example of a timer-programmed interrupt VLAN login setting window on the display screen of a panel 206. The administrator or user of an MFP 101 sets timer-programmed interrupt VLAN login of the MFP 101 by operating the setting window.

Fields 1501 and 1502 are used to input the registered user ID (login ID) and password of an authentication VLAN, about which the user inquires of the RADIUS server. A field 1503 is used to input the issue date/time (time and date) of the login request to the authentication VLAN. A field 1504 is used to input a logout time. The administrator or user of the MFP 101 sets timer-programmed interrupt login by inputting necessary information to these fields.

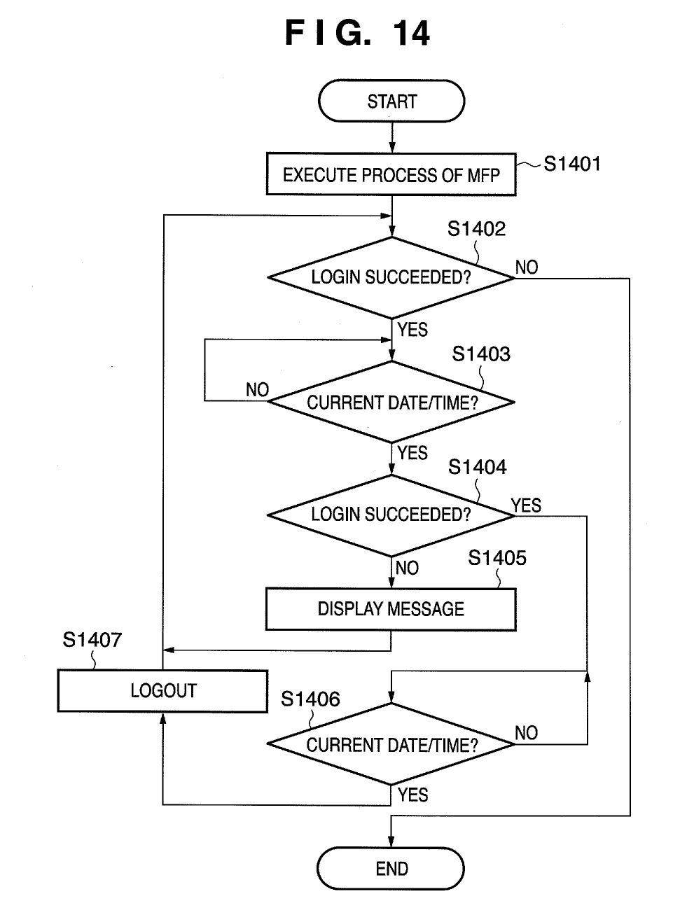

FIG. 14 is a flowchart showing an example process executed by the MFP 101 upon login using the window shown in FIG. 15.

In step S1401, the process of the MFP 101 is executed in accordance with the procedure shown in the flowchart of FIG. 9. In step S1402, it is checked in accordance with the procedure shown in the flowchart of FIG. 9 whether login to the authentication VLAN has succeeded. If login to the authentication VLAN based on the standard VLAN account has failed, the MFP 101 cannot execute IP communication. Hence, the process cannot continue any more. The process finishes here. That is, the process is ended after step S1402.

If login to the authentication VLAN based on the standard VLAN account has succeeded, the process advances from step S1402 to step S1403. The MFP 101 executes an interrupt login time-up waiting loop process. The interrupt login is a function of causing the MFP 101 to temporarily log in to a VLAN other than the VLAN set by the standard VLAN. Hence, in step S1403, an MFP control software 216 checks whether the time input to the field 1503 in the window shown in FIG. 15 is the current time counted by a CPU 201. If the time input to the field 1503 is the current time counted by the CPU 201, the process advances from step S1403 to step S1404. The MFP 101 issues an authentication VLAN login request to an authentication server 107 by using the registered user ID and password input in the window shown in FIG. 15. Issue of the authentication VLAN login request and the authentication process by the authentication server 107 and an authentication VLAN switch 108 are the same as the process in steps S906 to S917, and a description thereof will be omitted.

The MFP 101 receives information indicating whether the authentication has succeeded. If authentication has failed, the process advances from step S1404 to step S1405. An authentication VLAN login agent 217 displays, on the panel 206, a message indicating the failure of login to the authentication VLAN via the MFP control software 216. To log in to the standard VLAN again, the process returns to step S1402. With this process, the MFP 101 logs in to the preset standard VLAN in case of the failure of interrupt login.

If authentication has succeeded, the process advances from step S1404 to step S1406. The MFP 101 operates as a node on the VLAN set by the interrupt login. In this state, the user can operate the MFP 101 as a node on the VLAN designated by the setting items in FIG. 15 and therefore access, e.g., a destination different from the standard VLAN.

The MFP 101 checks whether the time input to the field 1504 in the window shown in FIG. 15 is the current time counted by the CPU 201. If the time input to the field 1503 is the current time counted by the CPU 201, the process advances from step S1406 to step S1407 to execute a logout process. The process returns to step S1402 to send a standard VLAN access request again. That is, when the interrupt login is ended, the MFP 101 automatically logs in to the standard VLAN.

As described above, according to this embodiment, it is possible to set the time of access to the authentication VLAN. Hence, an apparatus that normally accesses an authentication VLAN for general people can access another authentication VLAN only for a specific period (time). This also applies to logout.

The information input to the fields 1503 and 1504 is not limited to a time. A specific time of every specific day of the week, month/day/time, or so-called date/time may be input. Various methods are available to make the MFP 101 designate or decide the date/time of authentication VLAN login request issue to the authentication server 107 by using the registered user ID and password input in the window shown in FIG. 15. Any modification can be used if the login request is issued based on the date/time to be input and the current date/time.

The process described in the above embodiment can also be implemented by a configuration other than the system configuration shown in FIG. 1. More specifically, several apparatuses shown in FIG. 1 may be integrated into one apparatus. Alternatively, the process of one apparatus may be executed by a plurality of apparatuses.

According to the above-described embodiment, a printing environment that allows for easy use of an image forming apparatus in, e.g., a conference room at a specific timing (e.g., date/time) can be formed.

### Third Exemplary Embodiment

In the third embodiment, application examples of the above-described embodiments will be described.

An example using an FTP client software 220 in FIG. 2 will be described first. Assume that a standard VLAN to which an MFP 101 belongs is, e.g., a VLAN-10B in FIG. 10. The MFP 101 can communicate with PCs 103 and 105. The MFP 101 participates in the authentication VLAN-10B by executing the flowcharts in FIGS. 9 and 14 while inputting various kinds of information through the setting windows described with reference to FIGS. 8, 13, and 15 of the first embodiment.

When the MFP 101 participates in the authentication VLAN-10B, it is possible to transfer document data read by a scanner 214 to an FTP server running on the PC 105. More specifically, the MFP 101 connects to the FTP server running on the PC 105 and transfers scan data in accordance with the FTP protocol by using the FTP client software 220.

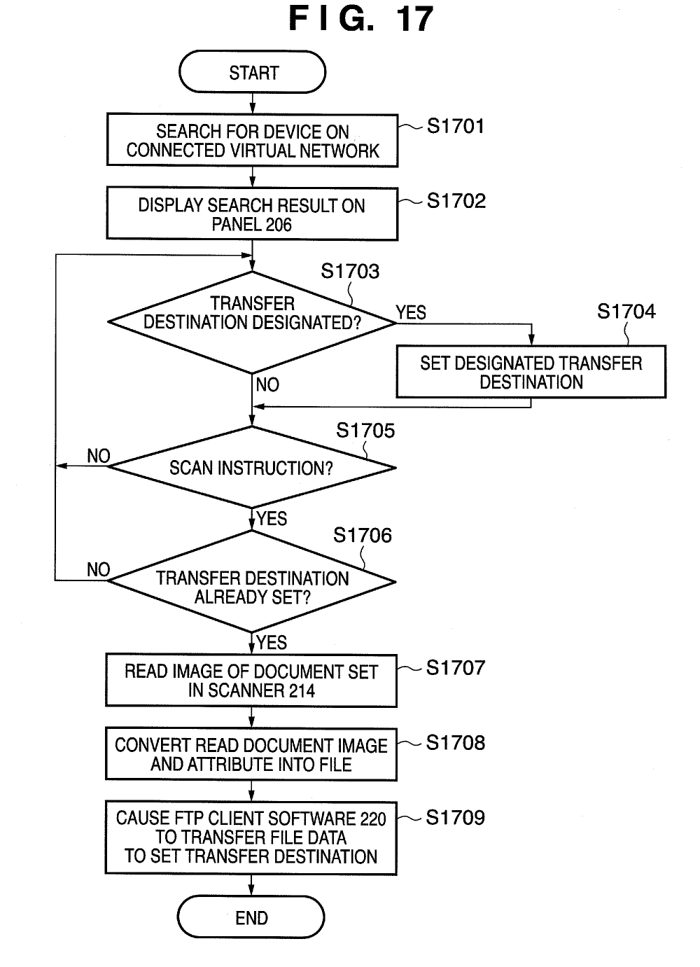

An example detailed process of the MFP will be described below in detail with reference to the flowchart in FIG. 17. The flowchart in FIG. 17 is executed when the flowcharts in FIGS. 9 and 14 of the first embodiment are executed to connect the MFP to a virtual network desired by the user.

First, a device on the currently connected authentication VLAN is searched for in step S1701. The device searched for here includes a PC and an MFP (image forming apparatus). Various search methods are available. A method using broadcast, a method using a designated IP address range, a method using a directly designated IP address, and a method using a device name are available. A transfer destination is designated.

In step S1702, the search result by the search process in step S1701 is displayed on a panel 206 of the MFP. The user selects an arbitrary transfer destination from the displayed devices.

In step S1703, it is determined whether the user has input a transfer destination designation through the panel 206 of the MFP. If the result is YES in step S1703, the designated transfer destination is set in step S1704. If the result is NO in step S1703, it is determined in step S1705 whether the user has input a read instruction, i.e., a scan instruction of the document image set on a scanner 214. If the result is NO in step S1705, the process returns to step S1703. If the result is YES in step S1705, it is determined in step S1706 whether the transfer destination has already been set in step S1704. If the result is YES in step S1706, the process advances to step S1707.

In step S1707, the image of the document set in the scanner 214 is read. In step S1708, the read image is sequentially converted into a file in accordance with an attribute such as a file name. As the file format, for example, PDF (Portable Document Format) developed by Adobe can be employed.

In step S1709, the FTP client software 220 transfers the file data obtained in step S1706 to the transfer destination set in step S1702 by the FTP protocol. Actual transfer by the FTP protocol is performed by causing a CPU 201 to execute the FTP client software 220 and cooperate with a network interface card 211.

In the flowchart of FIG. 17, the transfer destination is designated in step S1703 from the search result obtained in step S1701. However, the transfer destination may be set in step S1704 by directly inputting a path such as //XXX/YYY via the panel 206 of the MFP.

When the authentication VLAN is applied to an MFP, and the user uses an arbitrary MFP, it is possible to easily communicably connect the arbitrary MFP to a PC to be set by the user as the transfer destination without any cumbersome operation such as hub settings. For example, a document image read by the scanner of an MFP installed in, e.g., a conference room can easily be transferred to a user's desired PC.

In addition, when the MFP and PC are connected based on the authentication VLAN, any accident caused by a low security level can be prevented so that it is impossible to, e.g., connect an arbitrary PC to the MFP by setting the IP addresses and MAC addresses of both devices.

An example using Web server software in FIG. 2 will be described next. For example, when the MFP 101 participates in an authentication VLAN-10A shown in FIG. 10, the MFP 101 can communicate with PCs 102 and 104. Even in this case, the MFP 101 participates in the authentication VLAN-10A by executing the flowcharts in FIGS. 9 and 14 while inputting various kinds of information through the above-described setting windows described with reference to FIGS. 8, 13, and 15.

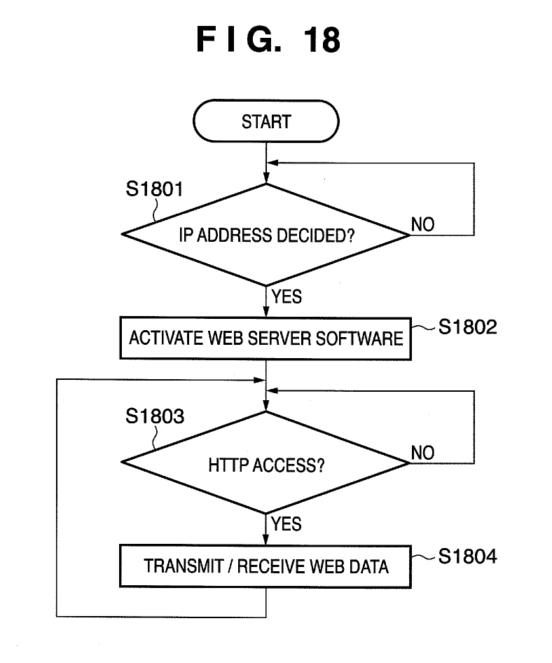

An example detailed process of the MFP will be described below in detail with reference to the flowchart in FIG. 18. The flowchart in FIG. 18 is executed when the flowcharts in FIGS. 9 and 14 of the first embodiment are executed to connect the MFP to a virtual network desired by the user.

In step S1801 in FIG. 18, Web server software 219 of the MFP 101 waits for activation. The Web server software 219 monitors the state of the IP address of the MFP 101 and executes an activation process when the IP address is decided. If the IP address of the MFP 101 is decided in step S917 in FIG. 9, the Web server software 219 advances to step S1802.

In step S1802, initialization and activation are executed to make the Web server software operate as a Web server. In this case, a series of processes including network socket generation and binding is executed to allow the Web server software 219 to communicate with an external node by the HTTP protocol. That is, when step S1802 is ended, a Web server is running on the MFP 101.

Step S1803 indicates a process of causing the Web server software 219 to wait for access by HTTP from an external node. If access from an external node such as the PC 102 or 104 that is participating in the authentication VLAN-10A has occurred in this state, the process advances to step S1804.

In step S1804, the Web server software 219 receives a predetermined instruction by the HTTP protocol and transmits/receives Web data. The predetermined instruction includes an acquisition instruction of Web page data held by the MFP 101.

This process allows the PCs 102 and 104 to access the Web server software 219 of the MFP 101 via the network in accordance with a user's operation. For example, the PC 102 can do network settings and refer to expendables and device information by accessing, using a Web browser, Web pages that are made open to the public by the Web server software 219 of the MFP 101.

The authentication VLAN is applied to the MFP in this way. By making, e.g., a notebook PC participate in the same authentication VLAN as the MFP to communicably connect the devices, the user can easily arbitrarily access both devices without any cumbersome operation such as hub settings.

In addition, when the MFP and PC are connected based on the authentication VLAN, the security level can be raised, and any accident can be prevented so that it is impossible to, e.g., connect an arbitrary PC to the MFP by setting the IP addresses and MAC addresses of both devices.

### Fourth Exemplary Embodiment

In the system described in the above embodiments, the authentication server 107 is set separately from the authentication VLAN switch serving as a switching device. However, each authentication VLAN switch may incorporate the function of the authentication server 107. In this case, an authentication request is sent to an authentication VLAN switch connected to each image forming apparatus, unlike the above-described embodiments wherein each image forming apparatus sends an authentication request to the authentication server 107.

That is, an image forming apparatus such as an MFP or a printer can send an authentication request not only to the authentication server 107 but also to various devices to change the communicable range.

### Other Exemplary Embodiments

The object of the present invention is also achieved by the following method. A recording medium (or storage medium) which records software program codes to implement the functions of the above-described embodiments is supplied to a system or apparatus. The computer (or CPU or MPU) of the system or apparatus reads out and executes the program codes stored in the recording medium. In this case, the program codes read out from the recording medium themselves implement the functions of the above-described embodiments. The recording medium that records the program codes constitutes the present invention.

When the computer executes the readout program codes, the operating system (OS) running on the computer partially or wholly executes actual processing based on the instructions of the program codes, thereby implementing the functions of the above-described embodiments.

The program codes read out from the recording medium are written in the memory of a function expansion card inserted into the computer or a function expansion unit connected to the computer. The CPU of the function expansion card or function expansion unit partially or wholly executes actual processing based on the instructions of the program codes, thereby implementing the functions of the above-described embodiments.

The recording medium to which the present invention is applied stores program codes corresponding to the above-described flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-089180 and filed Mar. 28, 2006 and No. 2007-022238, filed Jan. 31, 2007, which are hereby incorporated by reference herein in their entirety.

What is claimed:

1. An image forming apparatus connectable to a virtual network that requires an authentication process upon connection, the apparatus comprising:
an input unit configured to input authentication information corresponding to a virtual network of interest as a connection target of the image forming apparatus, wherein the virtual network of interest is part of a plurality of virtual networks;
a request unit configured to send, to an authentication unit, a connection request to the virtual network of interest, including the authentication information; and
a communication unit configured to communicate with an external device communicable in the virtual network of interest based on settings complying with a response from the authentication unit.

2. The apparatus according to claim 1, further comprising:
a receiving unit configured to receive, as the response, setting information corresponding to the authentication information from a switching device included in the virtual network; and
a setting unit configured to execute a setting process complying with the setting information,
wherein the communication unit executes access in the virtual network of interest in accordance with settings by the setting unit.

3. The apparatus according to claim 2, wherein the setting information includes an IP address on the virtual network of interest, and the setting unit executes a setting process complying with the IP address.

4. The apparatus according to claim 1, further comprising a unit configured to designate a time and date to make the communication unit connect to the virtual network of interest,
wherein the communication unit executes connection to the virtual network of interest based on a current time and date and the designated time and date.

5. The apparatus according to claim 1, further comprising an initial network connection unit configured to send a connection request to a predetermined network environment upon activation,
wherein communication with the authentication unit is performed in the predetermined network environment.

6. The apparatus according to claim 1, further comprising:
a scanner configured to read a document image; and
a transfer unit configured to transfer the document image read by the scanner to the external device communicable in the virtual network of interest.

7. The apparatus according to claim 1, further comprising a Web server,
wherein the Web server responds to access from the external device communicable in the virtual network of interest to the Web server.

8. A system comprising:
an image forming apparatus connectable to a virtual network that configured to utilize an authentication process upon connection, the image forming apparatus including,
an input unit configured to input authentication information corresponding to a virtual network of interest as a connection target of the image forming apparatus, wherein the virtual network of interest is part of a plurality of virtual networks;
a request unit configured to send, to the authentication unit, a connection request to the virtual network of interest, including the authentication information; and
a communication unit configured to communicate with an external device communicable in the virtual network of interest based on settings complying with a response from the authentication unit; and
an authentication unit including,
a holding unit configured to hold a plurality of sets of authentication information and setting information corresponding to the authentication information;
an acquisition unit configured to acquire, from the holding unit, setting information corresponding to the authentication information included in the connection request from the image forming apparatus; and
a transmission unit configured to transmit the setting information acquired by the acquisition unit to the image forming apparatus.

9. A method of controlling an image forming apparatus connectable to a virtual network that requires an authentication process upon connection, the method comprising:
inputting authentication information corresponding to a virtual network of interest as a connection target of the image forming apparatus, wherein the virtual network of interest is part of a plurality of virtual networks;
sending, to an authentication unit, a connection request to the virtual network of interest, including the authentication information; and
communicating with an external device communicable in the virtual network of interest based on settings complying with a response from the authentication unit.

10. A computer readable medium containing computer-executable instructions for controlling an image forming apparatus connectable to a virtual network that requires an authentication process upon connection, the medium comprising:
computer-executable instructions for inputting authentication information corresponding to a virtual network of interest as a connection target of the image forming apparatus, wherein the virtual network of interest is part of a plurality of virtual networks;
computer-executable instructions for sending, to an authentication unit, a connection request to the virtual network of interest, including the authentication information; and
computer-executable instructions for communicating with an external device communicable in the virtual network of interest based on settings complying with a response from the authentication unit.

11. A computer program stored on a readable medium comprising computer-executable instructions for controlling an image forming apparatus connectable to a virtual network that requires an authentication process upon connection, the program comprising:
computer-executable instructions for inputting authentication information corresponding to a virtual network of interest as a connection target of the image forming apparatus, wherein the virtual network of interest is part of a plurality of virtual networks;
computer-executable instructions for sending, to an authentication unit, a connection request to the virtual network of interest, including the authentication information; and
computer-executable instructions for communicating with an external device communicable in the virtual network of interest based on settings complying with a response from the authentication unit.
